(19) United States
(12) Patent Application Publication
(10) Pub. No.: US 2012/0127201 A1
(43) Pub. Date: May 24, 2012

(54) APPARATUS AND METHOD FOR PROVIDING AUGMENTED REALITY USER INTERFACE

(75) Inventors: Ki-Nam KIM, Goyang-si (KR); Hea-Beck YANG, Namyangju-si (KR); Seung-Jae LEE, Seoul (KR)

(73) Assignee: PANTECH CO., LTD., Seoul (KR)

(21) Appl. No.: 13/195,576

(22) Filed: Aug. 1, 2011

(30) Foreign Application Priority Data
Nov. 22, 2010 (KR) 10-2010-0116283

(51) Int. Cl. G09G 5/377

(52) U.S. Cl. 345/633

(57) ABSTRACT

An apparatus and method for providing an augmented reality user interface are provided. The method may be as follows. An augmented reality image is stored. The augmented reality is obtained by overlapping an image with augmented reality information, which is related to at least one object included in the image. The stored augmented reality image and an augmented reality image, which is captured in real time, are output through a divided display user interface at the same time.

### CROSS-REFERENCE TO RELATED APPLICATION

This application claims priority from and the benefit under 35 U.S.C. §119(a) of Korean Patent Application No. 10-2010-0116283, filed on Nov. 22, 2010, which is incorporated by reference for all purposes as if fully set forth herein.

### BACKGROUND

1. Field

The following description relates to an apparatus and method for providing augmented reality, and more particularly, to a user interface technique for providing augmented reality information.

2. Discussion of the Background

Augmented reality (AR) is a graphical scheme that allows virtual objects or information to be viewed in a real world environment, by combining or associating the virtual objects or information with the real world environment.

Unlike virtual reality, which displays virtual spaces and virtual objects, AR provides additional information obtainable in a view of the real world, by adding a virtual object and/or information to an image of the real world. That is, unlike virtual reality, which is applicable only to limited fields such as computer games, AR is applicable to various types of real world environments and has been viewed as a next generation display technology.

For example, if a tourist on a street in London points a camera of a mobile phone having various applications, such as a global positioning system (GPS), in a direction, AR information about a restaurant on the street or a shop having a sale, is overlapped with an image of the actual street, and displayed to the tourist.

If receiving augmented reality information at a specific time, such as the current time, according to the AR technique, a user may want to compare current AR information with previously received AR information. In order to acquire AR information related to an object, an image including the object needs to be taken at a location and a direction, such as the direction photographed. Accordingly, even though AR information about the object may have been previously searched, the user needs to move to the location and perform a search of the direction.

### SUMMARY

Exemplary embodiments of the present invention provide an apparatus and method for providing an augmented reality user interface, capable of searching an acquired image and augmented reality information included in the acquired image and storing the searched image and augmented reality information.

Additional features of the invention will be set forth in the description which follows, and in part will be apparent from the description, or may be learned by practice of the invention.

One exemplary embodiment provides for an apparatus to provide an augmented reality user interface, the apparatus including an image acquisition part to obtain an image, a display part to output augmented reality images, with each augmented reality image corresponding to a divided display and at least one augmented reality image corresponding to the image; and a control part to control each divided display individually.

Another exemplary embodiment provides for a method to provide an augmented reality user interface, the method including storing an augmented reality image that is obtained by corresponding an image with augmented reality information, based on one object included in the image; and outputting the stored augmented reality image and a current augmented reality image, via a divided display, a first part of the divided display to display the stored augmented reality image and a second part to display the current augmented reality image.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows an apparatus to provide an augmented reality user interface according to an exemplary embodiment.

FIG. 2 shows a divided display user interface to provide augmented reality according to an exemplary embodiment.

FIG. 3 shows an example of a list of tabs of a second sub-area according to an exemplary embodiment.

FIG. 4 shows an example of a display shift based on a drag signal according to an exemplary embodiment.

FIG. 5 shows an example of a display shift based on a drag signal according to an exemplary embodiment.

FIG. 6 shows another example of a sub-area of a display according to an exemplary embodiment.

FIG. 7 shows an example of the activation/inactivation state of the sub-area of a display according to an exemplary embodiment.

FIG. 8 shows an example of a method to provide a user interface according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art.

Hereinafter, examples will be described with reference to accompanying drawings in detail.

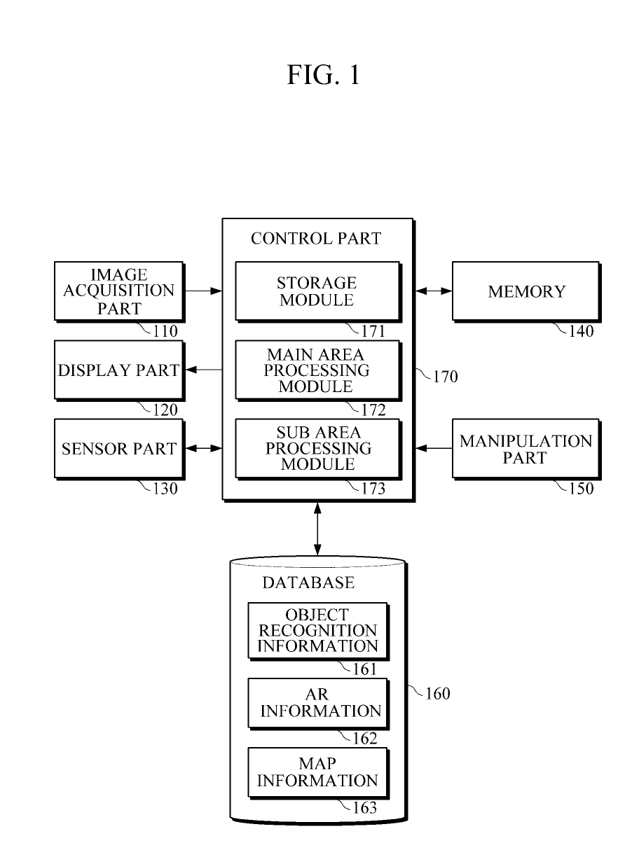

FIG. 1 shows an apparatus to provide an augmented reality user interface according to an exemplary embodiment.

As shown in FIG. 1, the apparatus to provide an augmented reality interface includes an image acquisition part 110, a display part 120, a sensor part 130, a memory 140, a manipulation part 150, a database 160 and a control part 170. The manipulation part 150 and the display part 120 may be combined into one unit and may be a touch screen (not shown).

The image acquisition part 110 may be implemented by a camera, an image sensor or a device that receives an image file. In addition, the image acquisition part 110 may be implemented by a camera with the capabilities to enlarge or reduce an acquired image through the control part 170 while taking a picture, or to rotate an acquired image in a manual or automatic manner. The object may represent a marker existing in a captured environment from the image, or a marker-less environment as well.

The display part 120 outputs an augmented reality image that is obtained by overlapping an image acquired by the image acquisition part 110 with augmented reality information, the information being related to at least one object included in the image. In one example of a display of an augmented reality image on the display part 120, the control part 170 outputs a divided display user interface that allows at least two augmented reality images to be included in a single display.

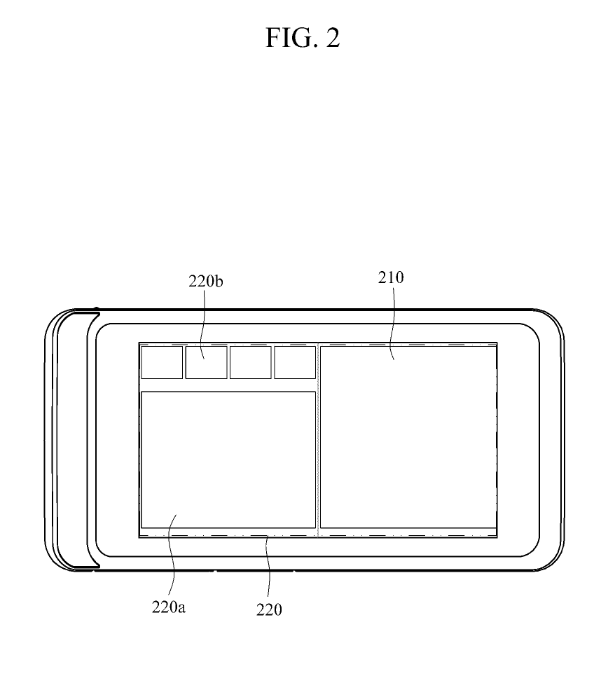

FIG. 2 shows a divided display user interface to provide augmented reality according to an exemplary embodiment.

Referring to FIG. 2, the user interface output on the display part 120 includes a main area 210 and a sub-area 220. The control part 170 outputs an augmented reality image, which may correlate to a current time, acquired by the image acquisition part 110, in the main area 210. According to another example, the main area 210 may output an augmented reality image stored in the memory 140. Thus, the main area 210 outputs an augmented reality image that may be of interest to a user.

The control part 170 controls the sub-area 220 to display an augmented reality image that is compared with the augmented reality image being displayed in the main area 210. The sub-area 220 is divided into at least a first sub-area 220a and a second sub-area 220b. The first sub-area 220a outputs an augmented reality image that is compared with the augmented reality image output on the main area 210. The second sub-area 220b outputs a list of tabs associated with the augmented reality images, which may be stored in the memory 140. The outputting of a list of tabs may be done in an organized and deliberate manner.

Referring again to FIG. 1, the sensor part 130 provides sensing information used to aid the control part 150 to detect an object from an image, or detects augmented reality data related to the detected object. For example, the sensing information may include a photographing location and a photographing direction. The sensor part 130 may include a global positioning system (GPS) receiver to receive signal information about the location of a camera and/or device from a GPS satellite, a gyro sensor to sense an azimuth angle and a tilt angle of a camera, and/or an accelerometer to measure and output a rotation direction and a rotation amount of a camera and/or device. According to this example, if an image rotation is acquired or detected, which may be caused by a rotation of a camera, the control part 160 may determine a time for photographing the image by receiving information about the change in location caused by the rotation from the sensor part 130.

The memory 140 stores an acquired augmented reality image, which may have been previously generated. The control part 170 detects the augmented reality image stored in the memory 140 and outputs the detected augmented reality image in the sub-area 220. The augmented reality images are divided and managed based on attributes associated with the detected object.

The manipulation part 150 included in the user interface is configured to receive information from a source, such as a user. For example, the manipulation part 150 may be implemented using a key panel to generate key data whenever a key button is pushed, a touch sensor or a mouse. However, other manipulation techniques may also be substituted and implemented. Thus, the manipulation part 150 may be used to input request information for requesting the storing of an image, selecting a sub-area activation/inactivation, and/or selecting an image to be output on the sub-area. In addition, the control part 170 may control the manipulation part 150 to output the augmented reality images in a list of tabs, for example, in a chosen order, sequentially, with the list being controlled through a left/right drag signal input. The control part 170 may detect map information corresponding to the image included the second sub-area 220b according to an upper/lower drag signal input from the manipulation part 150, and output the detected map information.

The database 160 stores information used in the various exemplary embodiments. As shown in FIG. 1, the database 160 may be implemented as a built-in component, or may be provided outside the apparatus to receive data through a network. In the latter case, the augmented reality user interface providing apparatus may further include a communication interface enabling a network communication to/from the database 160.

The database 160 includes object recognition information 161, augmented reality information 162 and map information 163. The object recognition information 161 represents object feature information that serves as mapping information used to recognize an object. The object feature information may include shapes, colors, textures, patterns, color histograms, edge information of an object, and the like. The control part 170 identifies the object included in an image through the object recognition information 161. In addition, according to this example, the object recognition information 161 may include information about the location of an object, for example, through the use of GPS data. That is, even an identical or similar object, which has the same or similar characteristic feature information as an identical or similar object, may be recognized as a different object based on the location of the object. The object recognized is assigned an identifier in order to distinguish the object. The augmented reality information 162 is information related to an object. If an exemplary object is a tree, augmented reality information of the tree may be the name of the tree, main habitations of the tree, and ecological characteristics of the tree that are represented in the form of a tag image(s). This augmented reality information may be assigned an identifier identical to that of the corresponding object and managed according to the assigned identifier. The map information 161 stores two-dimensional map information or real picture map information. The control part 170 may detect map information about the photographed location of an image output on the display part 120, via an upper/lower drag signal input of the manipulation part 150, and may output the detected map information.

The control part 170 controls the above components described above, thereby implementing the method to provide an augmented reality user interface via a divided display. The control part 170 may be implemented using a hardware processor or a software module, which may run on a hardware processor. The control part 170 includes a storage module 171, a main area processing module 172 and a sub-area processing module 173.

The storing module 171 is configured to store augmented reality images in the memory 140. The storing module 171 may store an augmented reality image currently outputted in the main area 210, if a request signal for storing is made. Also, the storing module 171 may perform a storing operation based on configuration information. For example, the storing module 171 may automatically perform storing based on a determination that a location of a user is not changed for a time, the location of the user being detected through sensing information from the sensor part 130. Further, if a request is made for a rotation image, which is taken while turning a camera, the storage module 171 automatically stores an augmented reality image if a user turns a camera at a specific angle, the angle being determined by the sensing information. In addition, the storing module 171 may classify and store the stored augmented reality image information depending on the attribute so that the augmented reality image information is more searchable, such as at a future time. In addition, if attribute information about the stored augmented reality information is input through the manipulation part 150, the storage module 171 may additionally tag the input attribute information to the augmented reality image information.

The main area processing module 172 performs control such that an augmented reality image is output in the main area 210 as shown in FIG. 2. For example, if a request is not input, the main area processing module 172 outputs a real time augmented reality image obtained by the image acquisition part 110. Thus, if a request is input through the manipulation part 150, the main area processing module 171 may detect and output a stored augmented reality image based on the input in addition to the real time image. In another example, at reception of an image acquisition stop request signal, the main area processing module 171 may perform controls such that an augmented reality image taken at the reception of the image acquisition stop request signal is output in the main area 210. The augmented reality image taken at the reception of the image acquisition stop request signal may be continuously output in the main area 210. In this manner, a user may compare an augmented reality image in the main area 210 with an augmented reality image in the sub-area 220 without having to maintain a photographed direction of a camera.

The sub-area processing module 173 searches for an augmented reality image, which may be selected from the memory 140 and outputs the searched augmented reality image in the sub-area 220. For example, if a request is not input, the sub-area processing module 173 may output the most recently stored image in the first sub-area 220a, and outputs a list, which may be image tabs, which may be arranged in the order the images were stored, on the second sub-area 220b. For example, the sub-area processing module 173 may search for an augmented reality image related to an object, the augmented reality image being selected via the manipulation part 150 from an augmented reality image output in the main area 210, from the memory 140 and output the searched augmented reality image on the sub-area 220. The sub-area processing module 173 may create a list, represented by tabs, for the second sub-area 220b by use of augmented reality images that are photographed, captured and/or stored based on a request for taking a picture while rotating the camera, and output an augmented reality image selected from the list of tabs in the first sub-area 220a.

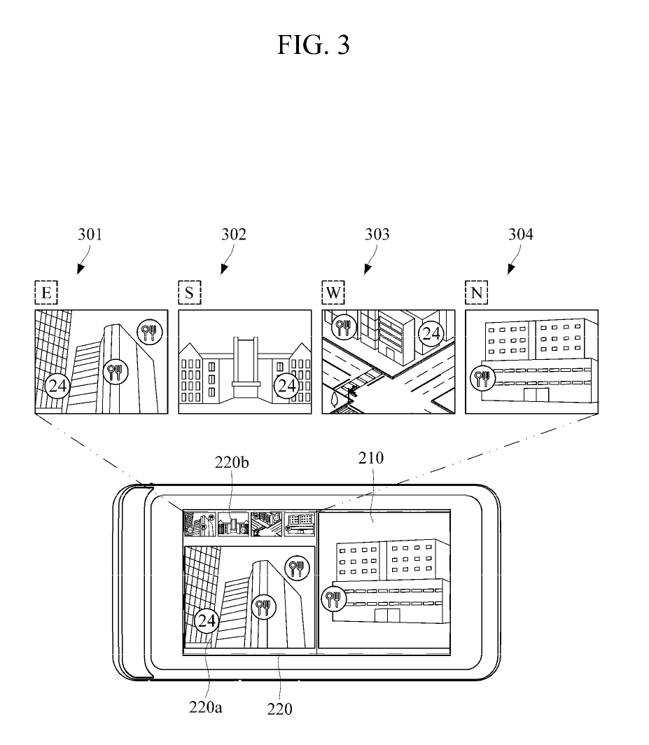

FIG. 3 shows an example of a list of tabs of a second sub-area according to an exemplary embodiment.

Referring to FIG. 3, augmented reality images based on directions of a camera or device's location are displayed as a list, as represented by the =tabs, in the second sub-area 220b. As shown in FIG. 3, the various directions are represented: east (E) 301, south (S) 302, west (W) 303, and north (N) 304.

In exemplary embodiments described below, various drag signal inputs are associated with specific processes described in this disclosure. However, one of ordinary skill in the art may substitute the various drag signal inputs with the various processes as described herein.

The sub-area processing module 173 may change an augmented reality image being displayed on the first sub-area 220a by use of a signal input via the manipulation part 150. For example, the sub-area processing module 173 may allow augmented reality images displayed as a list, as represented by the tabs of the second sub-area 220b, to be sequentially output based on a drag signal, such as a left/right operation, input through a touch screen.

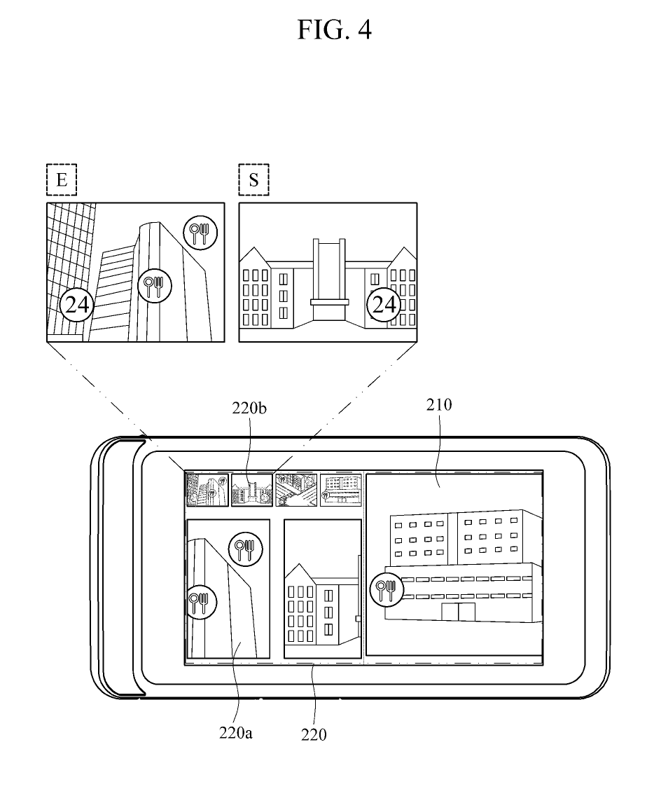

FIG. 4 shows an example of a display shift based on a drag signal according to an exemplary embodiment.

Referring to FIG. 4, if a left direction drag signal is input to the first sub-area 220a or the second display part 220b, the sub-area processing module 173 changes a screen of the sub-area 220 from an augmented reality image corresponding to the direction of east to an augmented reality image corresponding to the direction of south, thereby changing the view in one of the sub-areas to the corresponding selected image or the next image sequentially provided. Further, as shown in FIG. 4, the image in the sub-area 220 may depict the transition by showing a partial portion of the augmented reality image in the east direction and a partial portion of the augmented reality image in the south direction, during the transition.

In another example, the sub-area processing module 173 may detect map information stored in the memory 140 or the database 160 according to an upper/lower drag signal and output the detected map information.

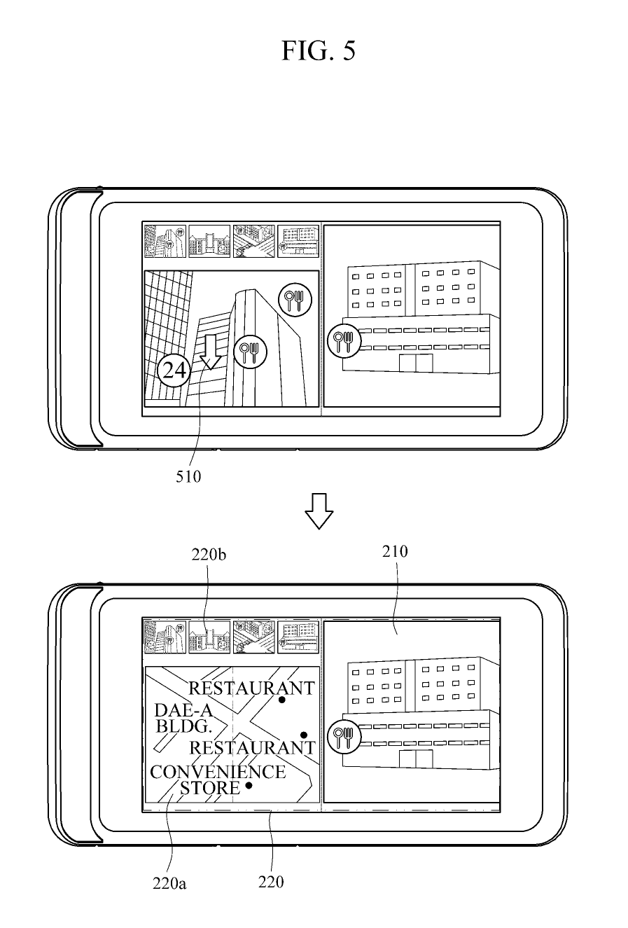

FIG. 5 shows an example of a display shift based on a drag signal according to an exemplary embodiment.

As shown in FIG. 5, if an augmented reality image corresponding to the direction of east is output, and if the upper/lower drag signal is input, map information corresponding to an individual direction is output. The map may be a two-dimensional map image or three-dimensional map image.

Based on the inputted drag signal, the sub-area processing module 173 may provide a three dimensional interface, such as a cubical interface, as a user interface.

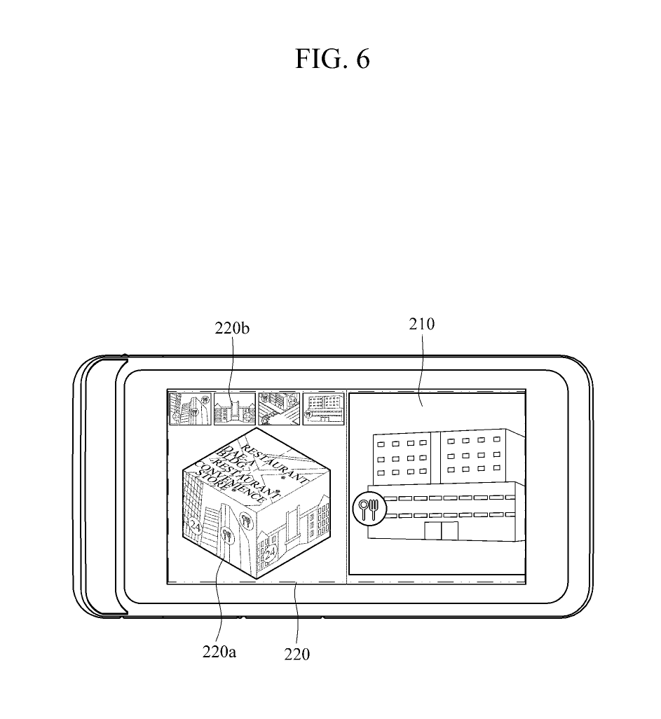

FIG. 6 shows another example of a sub-area of a display according to an exemplary embodiment.

As shown in FIG. 6, if the user interface is implemented in the form of a cubic representation, with its respective side surfaces of the cube representing a user interface that outputs images respectively corresponding to the directions of east, west, south and north. Two surfaces of the cube user interface may output map information. Accordingly, as a request for screen shift is input, the sub-area processing part 173 may display a surface of the cube user interface based on the request. In addition, if sub area inactivation is requested, the sub-area processing module 173 may allow the sub-area 220 to be inactivated on the display part 120.

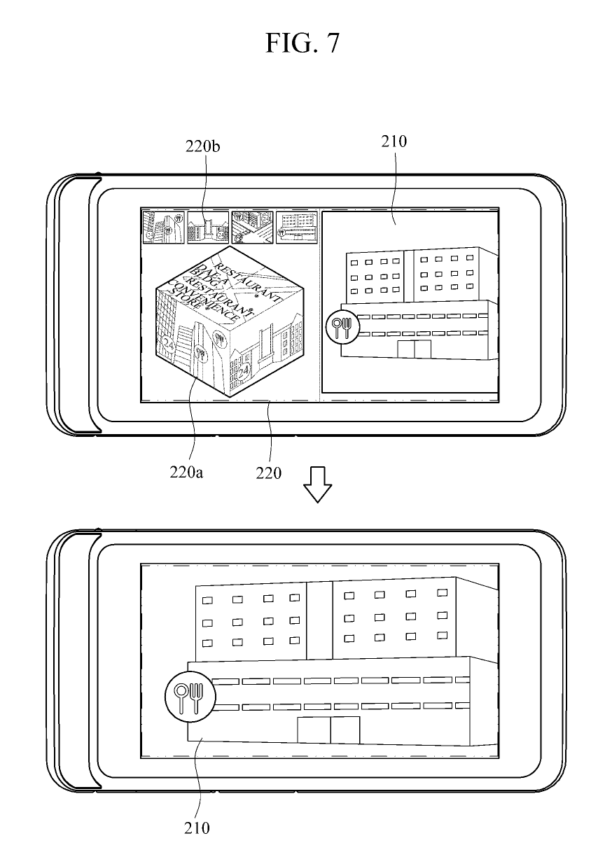

FIG. 7 shows an example of the activation/inactivation state of the sub-area of a display according to an exemplary embodiment.

Referring to FIG. 7, if a request for inactivation is input, the main area 210 is enlarged and shown on the entire area of the display part 120.

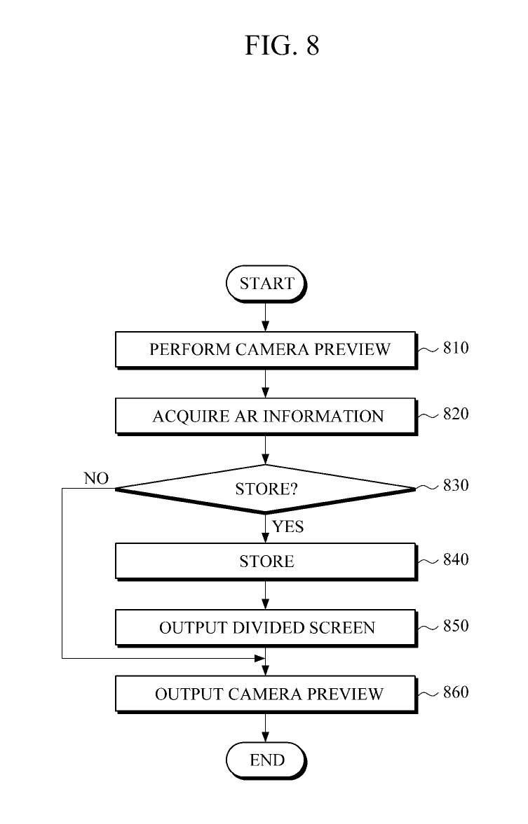

FIG. 8 shows an example of a method to provide a user interface according to an exemplary embodiment.

Referring to FIG. 8, the control part acquires an image based on a photographing direction and a photographing location and performs a preview operation of a camera in operation (810). The control part acquires augmented reality information related to at least one object included in the image acquired in operation 810 in operation (820). The control part creates an augmented reality image by adding the acquired augmented reality information to the image.

The control part determines whether to store the augmented reality image in operation (830). The control part determines whether to store the augmented reality image based on a request for storing or on other information, such as information that has been sensed. For example, if the sensing information is not changed for a specific time, the control part may determine to store the augmented reality image.

If it is determined to store the augmented reality image based on the determination in operation 830, the control part stores the augmented reality image in the memory in operation (840). In this case, the augmented reality images stored in the memory are output on the list of tabs of the second sub-area. The control part outputs the augmented reality image stored in the memory and a real time augmented reality image at the same time through a screen division user interface having a divided screen in operation (850). That is, an augmented reality image based on interest is output on the main area (210, in FIG. 2), and an augmented reality image to be compared with the augmented reality image output on the main area (210, in FIG. 2) is output on the sub-area (220, in FIG. 2). Although not shown, in a state that a user interface having a divided screen is output, the control may change a portion of the screen of the sub-area (220, in FIG. 2) according to the signal input. For example, the control part may sequentially output the stored augmented reality images according to a left/right drag signal. For example, the control part may detect and output map information corresponding to an image output on the sub-area (220, in FIG. 2) according to an upper/lower drag signal.

In a state an image being output on the main area (210 in FIG. 2) of the user interface changes based on the photographing location and the photographing direction, and if an image acquisition stop request signal is input by a user, the control part may continuously output an augmented reality image based on the image inputted at the image acquisition stop request signal, on the main area (210 in FIG. 2).

If it is determined not to store or maintain the augmented reality image based on the determination of operation 830, the control part may maintain an output of a preview screen output by a camera in operation (860).

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to provide an augmented reality user interface, the apparatus comprising:
an image acquisition part to obtain an image;
a display part to output augmented reality images, with each augmented reality image corresponding to a portion of a divided display and at least one augmented reality image corresponding to the image; and
a control part to control each divided display individually.

2. The apparatus of claim 1, further comprising a memory to store the augmented reality images,
wherein the control part stores the augmented reality images output in the memory.

3. The apparatus of claim 2, further comprising a sensor part to acquire information based on a location of a photographing device,
wherein the control part determines an augmented reality storage time of the augmented reality images being stored in the memory, based on the sensing part.

4. The apparatus of claim 2, wherein the divided display comprises:
a first area to output an augmented reality image based on selection; and
a sub-area to output an augmented reality image based on information from the memory compared with the augmented reality image output in the main area.

5. The apparatus of claim 4, wherein the sub-area comprises:
a first sub-area to output the augmented reality image of the sub-area; and
a second sub-area configured to output a list corresponding to augmented reality images stored in the memory.

6. The apparatus of claim 5, further comprising an input part to receive an input,
wherein the control part determines map information corresponding to the augmented reality image of the first sub-area, a drag signal input via the input part, and
the first sub-area outputs the map information.

7. The apparatus of claim 4, further comprising a manipulation part to receive an input,
wherein, if a stop request signal of an image acquisition is detected, the control part controls the main area to maintain an output of the augmented reality image corresponding to the image.

8. The apparatus of claim 4, wherein the control part provides the augmented reality user interface in a three-dimensional form, and
outputs the augmented reality user interface in the sub-area.

9. The apparatus of claim 4, wherein, if a request for inactivation of the sub-area is received, the control part outputs an enlarged display of the main area.

10. A method to provide an augmented reality user interface, the method comprising:
storing an augmented reality image that is obtained by associating an image with augmented reality information, based on at least one object included in the image; and
outputting the stored augmented reality image and a current augmented reality image, via a divided display, a first part of the divided display to display the stored augmented reality image and a second part to display the current augmented reality image.

11. The method of claim 10, wherein the storing of the augmented reality image comprises determining an augmented reality storage property according to sensing information obtained at a time of capture of an image used to generate the stored augmented reality image, including a photographing location and a photographing direction.

12. The method of claim 10, wherein the outputting of the augmented reality images comprises detecting map information corresponding to the augmented reality image according to an input signal, and outputting the map information.

13. The method of claim 10, wherein the outputting of the augmented reality images comprises, at reception of an image acquisition stop request signal, maintaining the output of an augmented reality image corresponding to a current time.

14. The apparatus of claim 1, wherein the control part controls each of the divided displays based on a sensed rotation of the image acquisition part.

15. The method of claim 10, wherein the current augmented reality image is an image captured in real time associated with augmented reality information.

16. The apparatus of claim 5, wherein the list corresponds to directions relative a current location of the apparatus.

17. The apparatus of claim 2, further comprising a sensor part to acquire information based on a direction of a photographing device, wherein the control part determines an augmented reality storage time of the augmented reality images stored in the memory, based on the sensing part.

18. The apparatus of claim 8, wherein the three-dimensional form is represented as a cube, and sides of the cube correspond to different directional orientations of the apparatus.

19. The apparatus of claim 8, wherein the display part outputs only the image if a specific input is received.

20. An apparatus to provide an augmented reality user interface, the apparatus comprising:
an image acquisition part to obtain a first image;
a storage unit to store a second image mapped to the first image and augmented reality based on the first and second image; and
a display part to retrieve the second image,
wherein the display part outputs the first and second image, and the augmented reality.
